(19) United States
(12) Patent Application Publication
(10) Pub. No.: US 2018/0101726 A1
(43) Pub. Date: Apr. 12, 2018

(54) Systems and Methods for Optical Character Recognition for Low-Resolution Documents

(71) Applicant: Insurance Services Office Inc., Jersey City, NJ (US)

(72) Inventors: Shuai Wang, Piscataway, NJ (US); Maneesh Kumar Singh, Lawrenceville, NJ (US)

(73) Assignee: Insurance Services Office Inc., Jersey City, NJ (US)

(21) Appl. No.: 15/729,358

(22) Filed: Oct. 10, 2017

Related U.S. Application Data
(60) Provisional application No. 62/406,665, filed on Oct. 11, 2016.
(60) Provisional application No. 62/406,272, filed on Oct. 10, 2016.

(51) Int. Cl. G06K 9/00; G06K 9/18; G06K 9/62

(52) U.S. Cl. CPC G06K 9/00463; G06K 2209/01; G06K 9/6256; G06K 9/18

(57) ABSTRACT

Systems and methods for optical character resolution (OCR) at low resolutions are provided. The system receives a dataset and extracts document images from the dataset. The system then segments and extracts a plurality of text lines from the document images. The system then processes the plurality of text lines using a Recurrent Neural Network (RNN) with Long Short Term Memory (LSTM) module to perform line OCR. Finally, the system generates a plurality of text strings corresponding to the plurality of text lines.

### RELATED APPLICATIONS

This application claims priority to U.S. Provisional Patent Application Ser. No. 62/406,272 filed on Oct. 10, 2016 and U.S. Provisional Patent Application Ser. No. 62/406,665 filed on Oct. 11, 2016, the entire disclosures of which are both hereby expressly incorporated by reference.

### BACKGROUND

### Field of the Disclosure

The present disclosure relates to computer vision systems and methods for detecting characters in a document. In particular, the present disclosure relates to systems and methods for optical character recognition for low-resolution documents.

### Related Art

Optical Character Recognition (OCR) is an important computer vision problem with a rich history. Early efforts at OCR include Fournier d'Albe's “Optophone” and Tauschek's “Reading Machine” which were developed to help blind people read.

Robust OCR systems are needed to digitize, interpret, and understand the vast multitude of books and documents that have been printed in the past few hundred years and continue to be printed at an ever-increasing pace. Accurate OCR systems are also needed because of the ubiquity of imaging devices such as smart phones and other mobile devices that allow a vast number of people to scan or image a document containing text. The need to exploit these technologies has also led to a variety of application-specific OCR solutions for receipts, invoices, checks, legal billing documents etc. OCR forms the key first step in understanding text documents from their images or scans.

OCR systems find use in extracting data from business documents such as checks, passports, invoices, bank statements, receipts, medical documents, business cards, forms, contracts, and other documents. For example, OCR can be used for license plate number recognition, books analysis, traffic sign reading for advanced driver assistance systems and autonomous cars, robotics, understanding legacy and historical documents, and for building assistive technologies for blind and visually impaired users among many others.

Current OCR systems do not perform well with low resolution documents, such as 150 dots per inch (“DPI”) or 72 DPI. For example, document OCR can follow a hierarchical schema, taking a top-down approach. For one page, the locations of text columns, blocks, paragraphs, lines, and characters are identified by page structure analysis. Due to the nature of touching and broken characters commonly seen in the machine printed text, segmenting characters can be more difficult than previous levels of page layout analysis. OCR systems requiring character segmentation often suffer from inaccuracies in segmentation. In such systems, distortions (e.g. skewed documents or low resolution faxes) can challenge both character segmentation and recognition accuracy. In fact, touching and broken characters often account for most recognition errors in these segmentation-based OCR systems.

Therefore, there exists a need for systems and methods for optical character recognition for low-resolution documents which address the foregoing needs.

### SUMMARY

Systems and methods for optical character resolution (OCR) at low resolutions are provided. A dataset is received and document images are extracted from the dataset. The system segments and extracts a plurality of text lines from the document images. The plurality of text lines are processed by a Recurrent Neural Network (RNN) with Long Short Term Memory (LSTM) modules to perform line OCR. Finally, a plurality of text strings are generated corresponding to the plurality of text lines.

A non-transitory computer-readable medium having computer-readable instructions stored thereon is also provided. The computer-readable medium, when executed by a computer system, can cause the computer system to perform the following steps. The computer-readable medium can receive a dataset and extract document images from the dataset. The computer-readable medium can segment and extract a plurality of text lines from the document images. The computer-readable medium can input the plurality of text lines into a Recurrent Neural Network (RNN) with Long Short Term Memory (LSTM) modules to perform line OCR. Finally, the computer-readable medium can generate a plurality of text strings corresponding to the plurality of text lines.

### BRIEF DESCRIPTION OF THE DRAWINGS

The foregoing features of the disclosure will be apparent from the following Detailed Description, taken in connection with the accompanying drawings, in which:

FIG. 1 is a flowchart illustrating processing steps carried out by the system of the present disclosure;

FIG. 2 is a flowchart illustrating processing steps for scanning documents;

FIG. 3 illustrates text lines that can be used for training and implementation;

FIG. 4 is a graph illustrating performance results the system of the present disclosure for OCR of low resolution documents on test data at different scan resolutions;

FIG. 5 illustrates text lines from a business dataset that can be used for training and implementation;

FIG. 6 is a graph illustrating performance results of the system of the present disclosure for OCR of low resolution documents on the business dataset at different scan resolutions;

FIG. 7 illustrates text lines from a contract document database and a UW-III dataset;

FIG. 8 is diagram illustrating hardware and software components of the system of the present disclosure; and

FIG. 9 is a diagram illustrating hardware and software components of a computer system on which the system of the present disclosure could be implemented.

### DETAILED DESCRIPTION

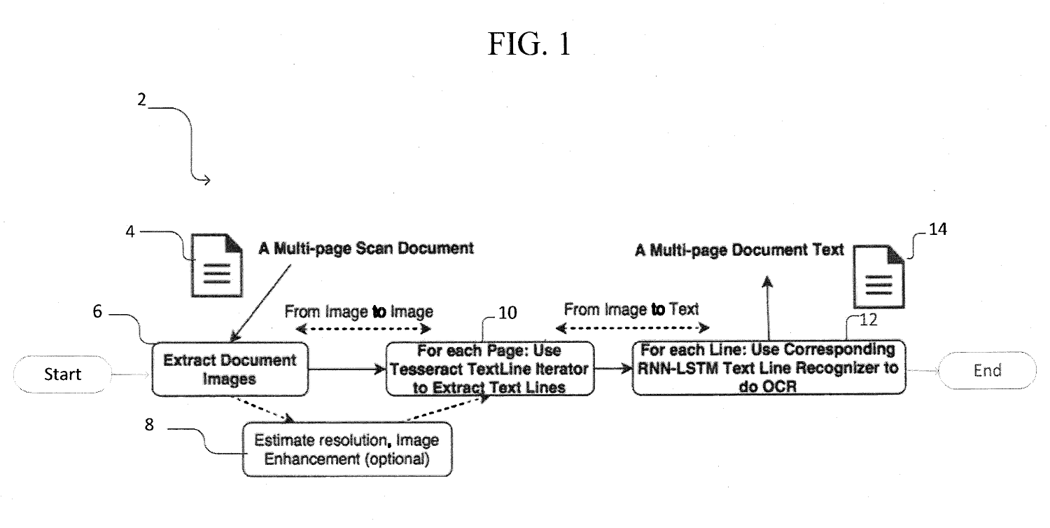

The present disclosure relates to systems and methods for optical character recognition on low-resolution documents, as discussed in detail below in connection with FIGS. 1-9.

In general, the performance of an OCR system depends on the number of pixels (e.g., Dots Per Character or “DPC”) used to represent the character, which can degrade as this quantity decreases. DPC can be proportional to the font size and scan resolution. The present disclosure relates to an OCR system for documents scanned at any resolution, including, but not limited to, documents scanned at very low resolutions such at 72 DPI or 150 DPI. The present disclosure is not limited to documents scanned in at these resolutions and can function with documents scanned at any resolution.

FIG. 1 is a flowchart illustrating processing steps 2 carried out by the system of the present disclosure. A document 4 can be scanned with a mobile device or scanner or any other known device for scanning. In step 6, the system extracts document images from the document 4. Optionally, in step 8, the system can estimate the resolution of the document. In step 10, the system processes the extracted document images using a text extraction module such as the known “Tesseract TextLine Iterator” to perform document structure analysis for segmenting and extracting text lines for each page of the document 4. The Tesseract OCR System is a known open-source system, the details of which can be found in R Smith, An Overview of the Tesseract OCR Engine. In Proceedings of the Ninth International Conference on Document Analysis and Recognition-Volume 02, pages 629-633 (IEEE Computer Society, 2007), which is hereby incorporated by reference in its entirety. In step 12, the system can apply a recursive neural network (“RNN”) long term short memory (“LTSM”) model to the extracted text lines to extract a text string representing characters associated with the text line (e.g., alpha-numeric and any other known symbol). The system can then assemble the extracted text lines to create an OCR document page, and can then output a multi-page document 14 which includes string characters (e.g., text) of the document 4 and which can be used by a computer as text strings. A user of a computer can also copy and paste text from the document 14 for any desired purpose, e.g., pasting the extracted text into a word processing document, spreadsheet, software code, etc.

As noted above, in step 10, the system can utilize the Tesseract process to perform document layout analysis for text image extraction followed by recognition of the segmented and extracted text. Tesseract can find lines, fit baselines to text lines, and segment the text lines into words and into characters as needed. The line finding and the baselines fitting processes in step 10 work for low resolution documents. Thus, step 10 of the present disclosure can be used to fairly robustly segment and extract the image of complete lines of text irrespective of the scan resolution.

In step 12, the scanned text line image can be scaled to a canonical size to normalize the text height and can use an RNN-LSTM module which is trained to provide robust recognition performance across a variety of scan resolutions from within 72 DPI to 300 DPI, above and below those numbers as well. The LSTM module implements a Statistical Machine Translation (SMT) model. It can convert from the space of a sequence of vertical columns of pixels to the sequence of English characters (along with white spaces and punctuation). At each time step, a vertical column of pixels can be input into the LSTM. Correspondingly, sequences of characters can be output at corresponding time steps. This approach is considerably more robust to decreasing scan resolution (and other resolutions) than segmentation-based OCR systems, because in such systems, words (and if needed, characters) are segmented and then recognized. Decrease in scan resolution can adversely impact segmentation accuracy which in turn can adversely affect the subsequent character recognition accuracy. Such systems also require a greater amount of processing power to perform OCR tasks, whereas the system of the present disclosure reduces the required processing of the computer by employing a two tier architecture of the Tesseract system and the RNN model.

The text line extraction module is somewhat independent of the resolution of the text and adapts well to changing text size due to the computation of text baselines. Further, the height-normalized text lines may not need segmentation into words and characters (which can be error-prone for low resolutions) and can be directly translated by the powerful Statistical Translation Model provided by the RNN-LSTM module.

As noted above, the document OCR system can have two main components—(i) Document Structure Analysis (e.g., the Tesseract system), and, (ii) Optical Character Recognition (the RNN-LTSM model). Tesseract can perform both phases and can extract entire text from the image of a document page. Alternatively, Tesseract can be used for the first component, and the RNN-LTSM model can be used for the OCR recognition to create a system which can efficiently handle OCR of documents of low resolutions such as below 300 DPI. As noted above, Tesseract is a document OCR system that can take as input the image of an entire page. It can first perform page layout analysis and iteratively perform segmentation into paragraphs, lines, words and characters. Then, segmented character images can be recognized using a pre-trained character recognizer. After some post-processing, the entire sequence of characters can be output. For the second component, the system can train one dimensional bidirectional RNN-LSTM models for OCR and achieved high accuracy on a dataset which has images scanned at a scan resolution of 300 DPI and lower.

Implementation and testing of the system of the present disclosure will now be explained in greater detail. To train the RNN and to evaluate the performance of the system, a corpus of annotated text document images at a variety of scan resolution in the range 72 DPI to 300 DPI can be used. A simulator can be used to generate text line images at a variety of scan resolutions. A generic system can take input either from labeled high resolution images or from text lines. For the latter, the text lines can be generated from scrapping the web for domain specific textual content.

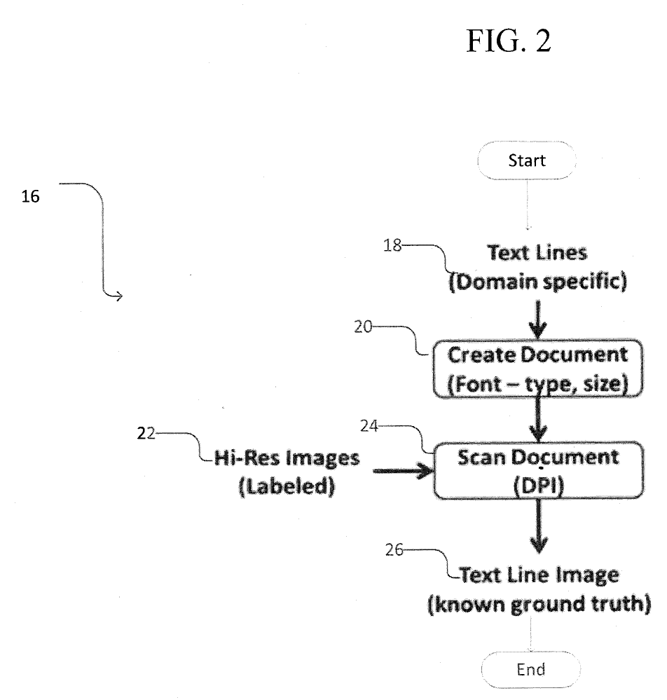

FIG. 2 is a flowchart illustrating processing steps 16 carried out by the system for scanning documents. In step 18, text lines which can be domain specific can be received and/or generated by the system. In step 20, a document can be created with a font size and type. In step 22, alternatively, high resolution images can be used in the process 16. In step 24, a document can be scanned in at a desired DPI. In step 26, text line images can be generated with known ground truth. High resolution images for testing can be used from the UW-III-SBI dataset. Postscript files can be generated and can subsequently be created at different resolutions using the Imagemagick tool. Postscript files can be commonly used as intermediate media before faxing. A C++ implementation of one-dimension bidirectional LSTM for OCR on text lines can be used. The parameters that are used can use the (target) height of input image to be fixed at 32 and momentum is set at 1e 4. Both left-to-right and right-to-left hidden layers can have 100 units.

Training of the models will now be described in greater detail. The UW-III English/Technical Document Image Database for training and evaluating the performance of the TesseRNN document OCR system. The dataset includes scanned document images from technical books, images, and reports written in English. Documents can be scanned at 300 DPI using a document scanner. For training the LSTM module, text line images that are known and publicly available can be used. For creating data at multiple resolutions, Imagemagick's Convert Command Line tools can be used. Original text line images are converted to postscript and then ImageMagick can be used to scan at different resolutions.

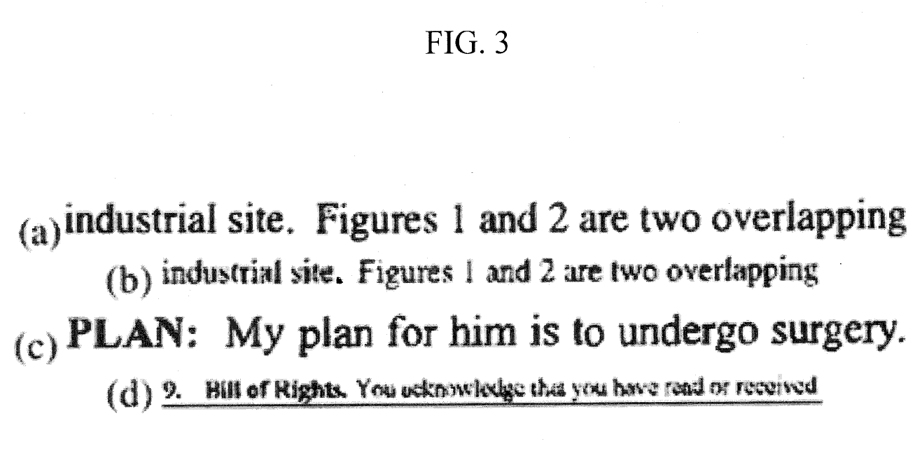

FIG. 3 illustrates text lines that can be used for training and implementation of the system of the present disclosure. Datasets with the following resolutions can be used for testing, training and experimentation: 72 DPI, 100 DPI, 150 DPI, 200 DPI, and 300 DPI. A text line is shown in (a) from the UW-III book images dataset scanned at 300 DPI while (b) shows the same image rendered using our scanner simulator at a resolution of 100 DPI as a fax transmission. Parts (c) and (d) shows two lines, with part (c) being 10 point font and part (d) being a lower font size. FIG. 3 shows that the scanned books data and the low resolution simulations can be fairly close in visual appearance to text of different font sizes in real documents. The UW3 image dataset can be split randomly into 95338 lines for training and 1020 for testing. To accommodate different input image heights, text line normalization on each input image can be done using spline interpolation. The systems can be setup with modes and parameters as discussed in above. The LSTM can be trained using the Forward-Backward algorithm for Connectionist Temporal Classification to find the best alignment between input frames of a text line image and the corresponding ground truth character sequence. One million training steps can be employed for training where models can be saved every 1000 steps. The labeling error rate can be calculated as the ratio of insertions, deletions, and substitutions relative to the length of the ground-truth, where the accuracy was measured at a character level.

Results of experimentation are now explained in greater detail. The test set can include 1020 text line images with total number of characters 48445. The labeling error rate was noted above. To evaluate the impact of scan resolutions, the test and training datasets can be created at 5 scan resolutions—72 DPI, 100 DPI, 150 DPI, 200 DPI and 300 DPI. The LSTM module can be trained on each of these resolutions.

Table 1 below is a table comparing performance results of prior systems and the system of the present disclosure for OCR of low resolution documents. For each row, data resolution refers to the resolution of the test data as well as training data used to train the present system.

| Resolution | Prior Art Systems | Example Embodiment |
|---|---|---|
| Data | Labelling Error | Labelling Error |
| 300 DPI | 2.54% | 0.57% |
| 200 DPI | 4.89% | 0.71% |
| 150 DPI | 11.06% | 0.83% |
| 100 DPI | 52.78% | 1.88% |
| 72 DPI | 83.66% | 8.05% |

At 300 DPI, the example embodiment of the present disclosure achieves 0.57% error rate. The error rate of prior art systems is higher at 2.54%. As the scan resolution goes down from 300 DPI to 72 DPI prior art accuracy rapidly degrades. At 150 DPI, the error jumps to more than 10 percent (11.06%), and at 100 DPI (52.78% error) and 72 DPI (83.66%), it is virtually unusable. The performance of an example embodiment of the present disclosure starts at 0.57% for 300 DPI but stays less than 2 percent (1.88%) at 100 DPI which is better than what prior art systems achieves at 300 DPI. At 72 DPI, the error rate of the embodiment still stays below 10 percent (a useful 8.05%).

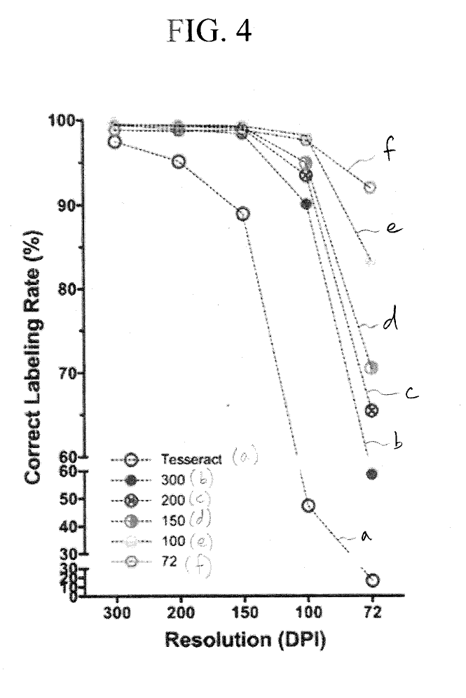

FIG. 4 is a graph illustrating performance results the system of the present disclosure for OCR of low resolution documents on test data at different scan resolutions. An example embodiment of the present disclosure trained on data at any resolution maintains near perfect performance for all scan resolutions 150 DPI and higher. The performance of models trained on low resolution data are almost as good as those trained on high resolution data when tested on higher resolution text images (150 DPI or above). The models trained on low resolution data significantly outperform models trained on high resolution data when tested on low resolution text images (100 DPI, 72 DPI). FIG. 4 suggest that the example embodiment trained at 72 DPI can be used across a full range of scan resolutions (72 DPI to 300 DPI) with an expected performance real best (or best) across the entire range. Beyond 300 DPI all implementations are expected to perform very well.

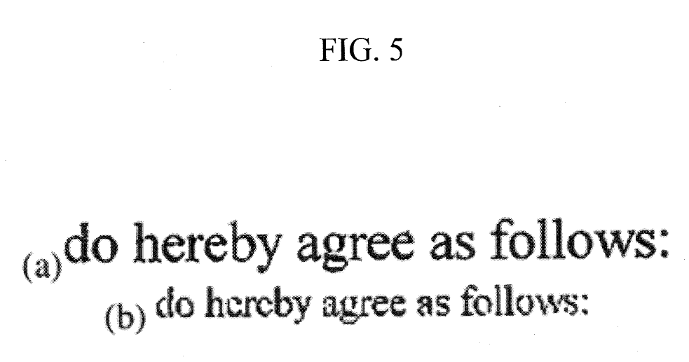

FIG. 5 illustrates text lines from a dataset that can be used for training and implementation of the system of the present disclosure. Testing with this business dataset will now be explained in greater detail. 192 lines (15784 characters) can be extracted from contract documents scanned at 300 DPI. Images at different resolutions can be generated using the approach described in greater detail above. Tesseract can be used as explained above to extract text line images and to pad them with a small margin (5% of image height). The system can be trained on UW-III dataset for automatic text extraction. Ground truth annotations can be prepared. In FIG. 5, the top image (a) corresponds to a line image extracted from the document (300 DPI) and the bottom image (b) was generated by the scan simulator at 100 DPI via fax.

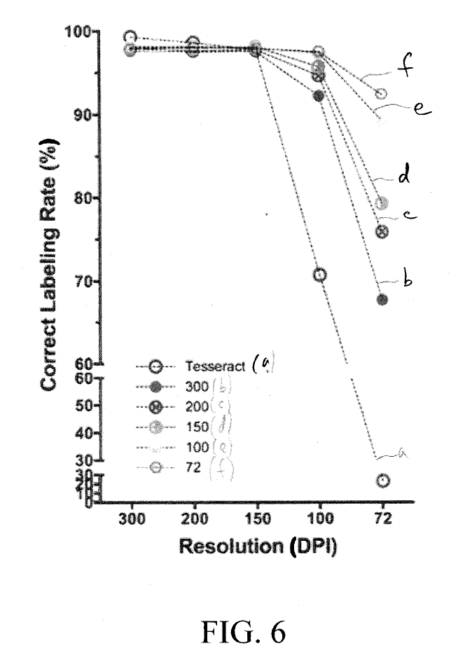

FIG. 6 is a graph illustrating performance results of the system of the present disclosure for OCR of low resolution documents on the dataset at different scan resolutions. Similar to the dataset discussed above, an example embodiment of the system of the present disclosure was trained with datasets at different resolutions. As can be seen the prior art Tesseract only system performs poorly on lower resolutions and the example embodiment of the system of the present disclosure performs well for lower resolutions.

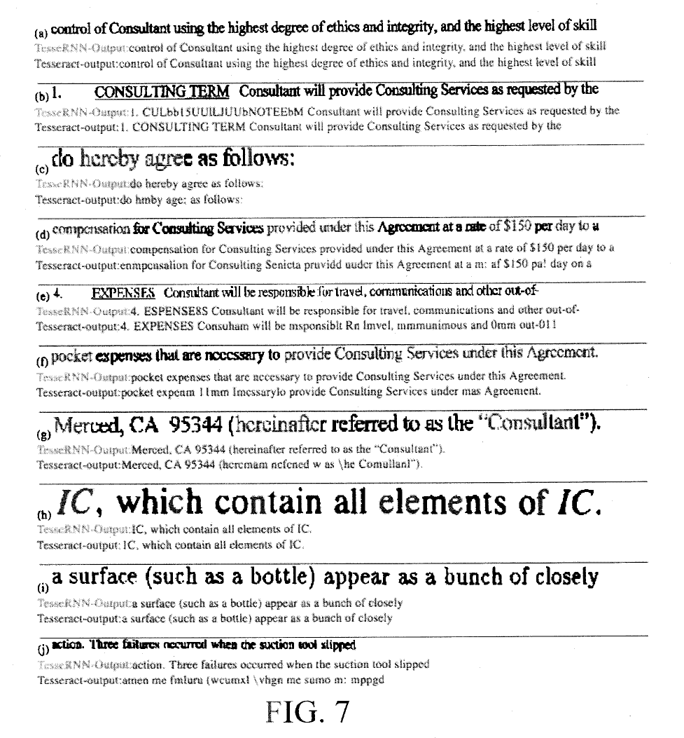

FIG. 7 is a drawing showing examples of text lines from a contract document database and a UW-III dataset. In particular, text lines (a)-(h) are from a contract documents dataset at various scan resolutions, and text lines (i)-(j) are from UW-III dataset. As can be seen, the system of the present disclosure recognizes the text accurately.

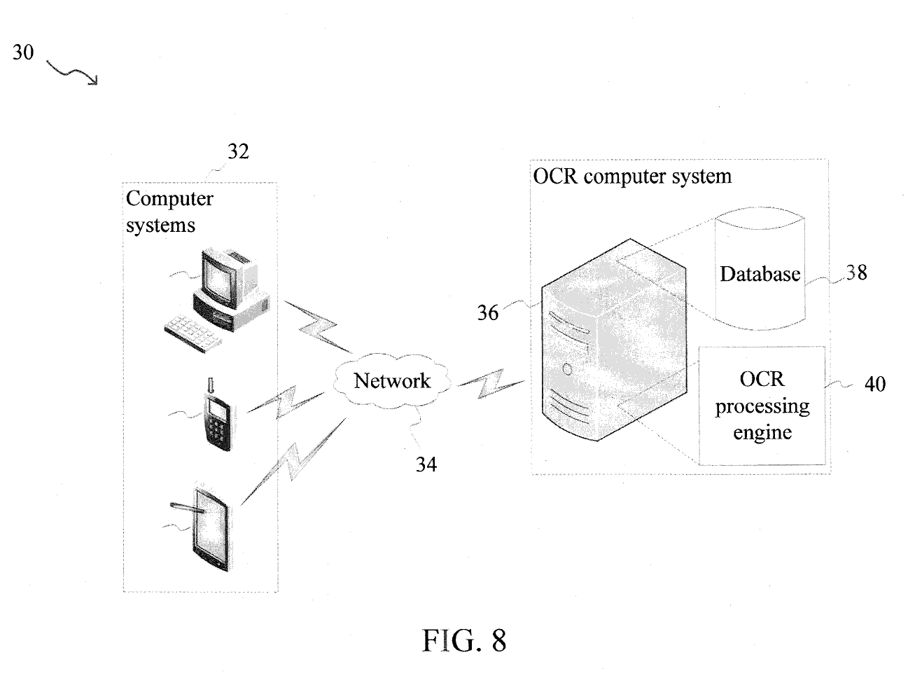

FIG. 8 is a system diagram of an embodiment of a system 30 of the present disclosure. The system 30 can include at least one computer system 32. The computer system 32 can receive or generate a dataset which can be scanned in. The computer system 32 can be a personal computer having a scanner connected thereto for receiving scanned images. The computer system 32 can also be a smartphone, tables, laptop, or other similar device. The computer system 32 could be any suitable computer server (e.g., a server with an INTEL microprocessor, multiple processors, multiple processing cores) running any suitable operating system (e.g., Windows by Microsoft, Linux, etc.). The computer system 32 can also receive wireless or remotely the dataset having the computer images to be processed by the OCR process of the present disclosure. The computer system 32 can communicate over a network 34 such as the Internet. Network communication could be over the Internet using standard TCP/IP communications protocols (e.g., hypertext transfer protocol (HTTP), secure HTTP (HTTPS), file transfer protocol (FTP), electronic data interchange (EDI), etc.), through a private network connection (e.g., wide-area network (WAN) connection, emails, electronic data interchange (EDI) messages, extensible markup language (XML) messages, file transfer protocol (FTP) file transfers, etc.), or any other suitable wired or wireless electronic communications format. The computer system 32 can communicate with a OCR computer system 36 having a database 38 for storing a the images to be processed with OCR and for storing images for training the RNN as described above. Moreover, the OCR computer system 36 can include a memory and processor for executing computer instructions. In particular, the OCR computer system can include a OCR processing engine 40 for executing the processing steps described in greater above for performing OCR on documents.

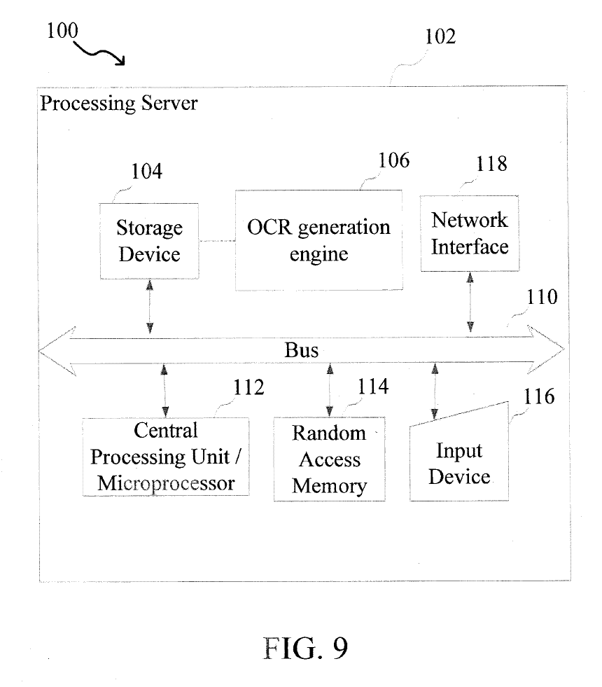

FIG. 9 is a diagram showing hardware and software components of a computer system 100 on which the system of the present disclosure could be implemented. The system 100 comprises a processing server 102 which could include a storage device 104, a network interface 108, a communications bus 110, a central processing unit (CPU) (microprocessor) 112, a random access memory (RAM) 114, and one or more input devices 116, such as a keyboard, mouse, etc. The server 102 could also include a display (e.g., liquid crystal display (LCD), cathode ray tube (CRT), etc.). The storage device 104 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The server 102 could be a networked computer system, a personal computer, a smart phone, tablet computer etc. It is noted that the server 102 need not be a networked server, and indeed, could be a stand-alone computer system. The functionality provided by the present disclosure could be provided by an OCR generation program/engine 106, which could be embodied as computer-readable program code stored on the storage device 104 and executed by the CPU 112 using any suitable, high or low level computing language, such as Python, Java, C, C++, C#, .NET, MATLAB, etc. The network interface 108 could include an Ethernet network interface device, a wireless network interface device, or any other suitable device which permits the server 102 to communicate via the network. The CPU 112 could include any suitable single- or multiple-core microprocessor of any suitable architecture that is capable of implementing and running the OCR generation program 106 (e.g., Intel processor). The random access memory 114 could include any suitable, high-speed, random access memory typical of most modern computers, such as dynamic RAM (DRAM), etc.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A method for optical character recognition (OCR) comprising:
receiving a dataset;
extracting document images from the dataset;
segmenting a plurality of text lines from the document images;
extracting the plurality of text lines from the document images;
processing the plurality of text lines using a Recurrent Neural Network (RNN) with Long Short Term Memory (LSTM) modules to perform line OCR; and
generating a plurality of text strings corresponding to the plurality of text lines.

2. The method of claim 1, further comprising the step of assembling the plurality of text strings to form a plurality of document pages.

3. The method of claim 2, further comprising the step of assembling the plurality of document pages to generate an OCR document.

4. The method of claim 1, wherein the dataset is scanned at a resolution below 300 dots per inch.

5. The method of claim 4, further comprising the step of estimating image resolution of the dataset.

6. The method of claim 5, further comprising the step of enhancing the image resolution of the dataset.

7. The method of claim 4, wherein the dataset is scanned at a resolution of 72 dots per inch.

8. The method of claim 1, further comprising the step of training the RNN-LTSM model with images having resolution of 72 dots per inch.

9. The method of claim 1, further comprising the step of training the RNN-LTSM model with images having resolution of below 300 dots per inch.

10. A non-transitory computer-readable medium having computer-readable instructions stored thereon which, when executed by a computer system, cause the computer system to perform the steps of:
receiving a dataset;
extracting document images from the dataset;
segmenting a plurality of text lines from the document images;
extracting the plurality of text lines from the document images;
processing the plurality of text lines using a Recurrent Neural Network (RNN) with Long Short Term Memory (LSTM) modules to perform line OCR; and
generating a plurality of text strings corresponding to the plurality of text lines.

11. The computer-readable medium of claim 10, further comprising the step of assembling the plurality of text strings to form a plurality of document pages.

12. The computer-readable medium of claim 11, further comprising the step of assembling the plurality of document pages to generate an OCR document.

13. The computer-readable medium of claim 10, wherein the dataset is scanned at a resolution below 300 dots per inch.

14. The computer-readable medium of claim 13, further comprising the step of estimating image resolution of the dataset.

15. The computer-readable medium of claim 14, further comprising the step of enhancing the image resolution of the dataset.

16. The computer-readable medium of claim 15, wherein the dataset is scanned at a resolution of 72 dots per inch.

17. The computer-readable medium of claim 10, further comprising the step of training the RNN-LTSM model with images having resolution of 72 dots per inch.

18. The computer-readable medium of claim 10, further comprising the step of training the RNN-LTSM model with images having resolution of below 300 dots per inch.

19. A system for optical character recognition (OCR) comprising:
a scanner for scanning a document;
a computer system in communication with the scanner and receiving the document, wherein the computer system:
extracts document images from the scanned document;
segments a plurality of text lines from the document images;
extracts the plurality of text lines from the document images;
processes the plurality of text lines using a Recurrent Neural Network (RNN) with Long Short Term Memory (LSTM) modules to perform line OCR; and
generates a plurality of text strings corresponding to the plurality of text lines.

20. The system of claim 19, wherein the computer system assembles the plurality of text strings to form a plurality of document pages.

21. The system of claim 20, wherein the computer system assembles the plurality of document pages to generate an OCR document.

22. The system of claim 19, wherein the computer system estimates image resolution of the dataset.

23. The system of claim 22, wherein the computer system enhances the image resolution of the dataset.
